(19) United States
(12) Patent Application Publication
(10) Pub. No.: US 2006/0005903 A1
(43) Pub. Date: Jan. 12, 2006

(54) Non-pneumatic wheel

(76) Inventors: Timothy Lee Fry, Akron, OH (US); David Alan Bloniarz II, Akron, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/886,884

(22) Filed: Jul. 8, 2004

(51) Int. Cl. B60C 7/00

(52) U.S. Cl. 152/1; 152/246; 152/323

(57) ABSTRACT

A non-pneumatic wheel has a mounting means, a tread support, and a tread. The tread is an annular article defined by opposing lateral edges and a ground contacting surface that forms the ground contacting means for the non-pneumatic wheel system. The internal construction of the tread includes a belt package, a primary reinforcement layer and a pair of hoop reinforcements in the lateral edges. The hoop reinforcements are located radially inward and axially outward of the ground contacting surface.

### FIELD OF THE INVENTION

The present invention is directed to a non-pneumatic wheel. More specifically, the present invention is directed to a covering, or tread package, for a non-pneumatic wheel and the mounting rim upon which the tread package is mounted.

### BACKGROUND OF THE INVENTION

Non-pneumatic wheels are well known and conventional. Such wheels have been used in numerous conditions and situations; the use being as diverse as mining operations to spare tires.

Additionally, various tread, or track-like, coverings for contact with road surfaces have been known in the art, such as those disclosed in U.S. Pat. No. 2,142,315 (Hershey), U.S. Pat. No. 3,149,656 (Johnson), and U.S. Pat. No. 3,326,261 (Young). Hershey discloses a replaceable covering for a tire. The covering has a pair of extending flanges having therein metal rings. Johnson discloses a renewable tread wherein the tread fits into slots on the tire casing. Young discloses a retreading operation wherein the carcass is buffed down and provided with mechanical locking means to interact with the replacement tread. The replacement tread may be provided with a pair of flanges, each flange containing therein a continuous metal cord.

U.S. Pat. No. 5,450,887 (Habay) discloses a similar tread covering having metal reinforced edges similar to the previously noted patents. However, the tread of Habay is mounted on a rigid support, the rigid support being mounted in the interior of a pneumatic tire to provide support for the pneumatic tire in the event of reduced pressure operation.

### SUMMARY OF THE INVENTION

The present invention is directed to a non-pneumatic wheel system designed for reduced weight and to eliminate flat tires during operation of the wheel. The invention has a mounting means, a tread support, and a tread. The tread is an annular article defined by opposing lateral edges and a ground contacting surface that forms the ground contacting means for the non-pneumatic wheel system. The internal construction of the tread includes a belt package, a primary reinforcement layer and a pair of hoop reinforcements in the lateral edges. The hoop reinforcements are located radially inward and axially outward of the ground contacting surface.

In one aspect of the invention, the primary reinforcement layer of the tread is a cord reinforced layer. The cords of the layer are inclined at an angle in the range of 0° to 15° relative to the circumferential direction of the tread. The material forming the cords may be steel, aramid, and nylon.

In another aspect of the invention, the ground contacting surface of the tread has a defined width W. The primary reinforcement layer is a cord reinforced layer and has an axial width WR between the outermost reinforcing cords. The width WR of the primary reinforcing layer is preferably less than the width W of the ground contacting surface.

In another aspect of the invention, in the tread, the belt package is located radially outward of the primary reinforcing layer, and is comprised of at least two layer of cord reinforced ply.

In another aspect of the invention, in the tread, the hoop reinforcements are located radially inward of the primary reinforcing layer. The hoop reinforcements may be enveloped by elastomeric chipper layers.

In another aspect of the invention, the tread support is an annular article defined by opposing lateral edges. The tread support has a central rim upon which the tread is positioned and mounting wells at each lateral edge. When the tread is placed on the tread support, the hoop reinforcements of the tread sit within the mounting wells.

In another aspect of the invention, the mounting wells of the tread support may be either continuous or discontinuous along the annular length of the tread support.

In another aspect of the invention, the tread support also has a flange located at the axially outer side of each mounting well. The flanges may be continuous or discontinuous and also may be integrally formed with the tread support or mechanically secured to the tread support.

The present invention may also be characterized by the relationship of the internal components of the tread. In that aspect of the invention, the non-pneumatic wheel system has the following components: a mounting means, a tread support, and a tread. The tread has a belt package, a primary reinforcement layer and a pair of hoop reinforcements in the lateral edges. The hoop reinforcements of the tread are located radially inward and axially outward of the primary reinforcement layer.

### BRIEF DESCRIPTION OF THE DRAWINGS

The invention will be described by way of example and with reference to the accompanying drawings in which:

FIG. 1 is a cross sectional view of a portion of a non-pneumatic wheel;

FIG. 2 is a perspective cut view of the tread;

FIG. 3 is a forward view of the tread support;

FIG. 4A is an alternative embodiment of the tread support; and

FIG. 4B is side view of the tread support of FIG. 4A.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims. The reference numerals as depicted in the drawings are the same as those referred to in the specification. For purposes of this application, the various embodiments illustrated in the figures each use the same reference numeral for similar components. The structures employed basically the same components with variations in location or quantity thereby giving rise to the alternative constructions in which the inventive concept can be practiced.

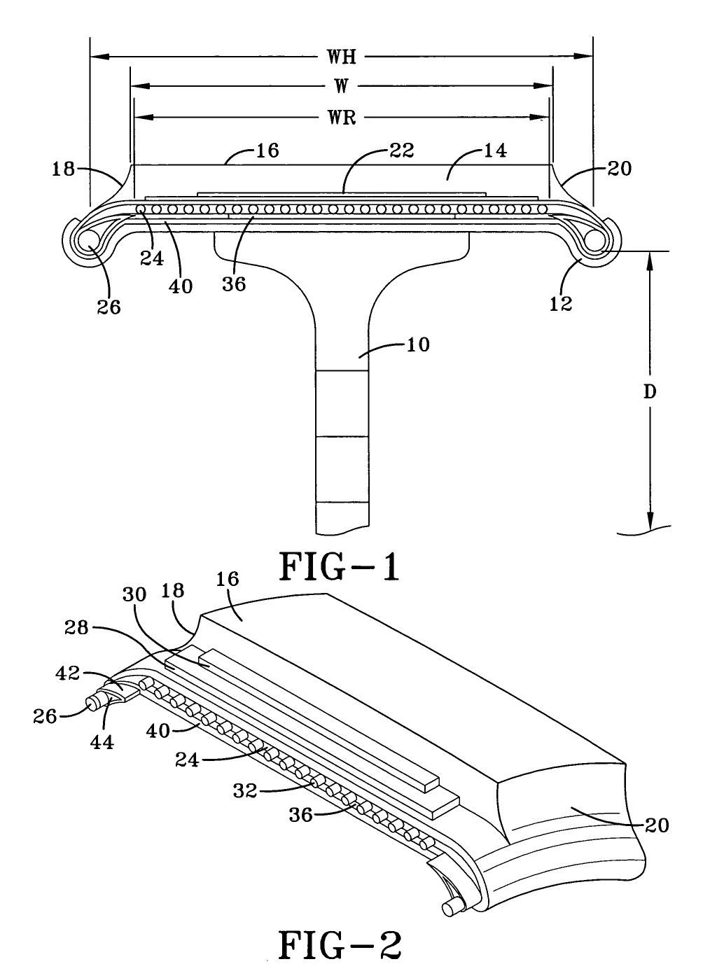

FIG. 1 illustrates a non-pneumatic wheel in accordance with the present invention. The wheel has three primary elements: the mounting means or wheel center 10, the tread support or rim 12, and the track or tread 14. The tread support 12 is fixedly secured to the mounting means 10; either being formed integrally with the mounting means 10 or being mechanically secured to the mounting means 10. The tread 14 is mounted onto the tread support 12 and establishes a ground contact surface for the non-pneumatic wheel. The entire radially inner surface of the tread 14 contacts the tread support 12.

The tread 14, shown in cut-away section in FIG. 2, is a unitary annular article and has a ground contacting surface 16. The ground contacting surface 16 has opposing lateral edges 18, 20. The ground contact surface 16 is shown with no surface features; however, any groove or tread pattern may be provided. The ground contacting surface 16 has a width W. Radially inward of the ground contacting surface 16 is a belt package 22. Radially inward of the belt package 22 is a primary reinforcement layer 24. At the extreme lateral edges are hoop reinforcements 26.

The belt package 22 has at least two cord reinforced layers 28, 30. The radially inner layer 28 has an axial width greater than the radially outer layer 30. The cords are formed of materials such as steel, aramid, nylon, polyester, cotton, and blends of these materials. The cords have a diameter in the range of 0.35 to 1.5 mm. The cords in each layer are inclined at angles of 10° to 45° relative to the circumferential direction of the belt package, with the cords in each layer being crossed relative to the cords in the adjacent layer.

The primary reinforcement layer 24 is located radially inward of the belt package 22. The primary reinforcement layer 24 is comprised of at least a single layer of large diameter, low angle reinforcing cords 32. The cords 32 have a diameter greater than the diameter of the cords in the belt package cord reinforced layers 28, 30. The large diameter cords 32 enable the tread 14 to achieve a high tension between the tread 14 and the wheel 10. A minimum of 100 lbs. of tension between the tread 14 and the wheel 10 is desired. The minimum tension for any non-pneumatic wheel according to the present invention is equal to the actual load that will be placed on the wheel. The diameter of the cords 32 is in the range of 1.4 mm to 7.6 mm. The cords are inclined at an angle in the range of 0° to 15° relative to the circumferential direction of the tread. The cords are formed from high modulus materials such as steel or aramid, or may be blended with other modulus materials such as nylon and polyester.

The axial width between the axially outermost cords 32 of the primary reinforcement layer 24 define the axial width WR of the primary reinforcing layer. The width WR is in the range of 85 to 130% of the axial width W of the ground contacting surface 16.

Radially inward of the primary reinforcing layer may be a secondary belt package comprising at least one cord reinforced layer 36. The layer 36 is formed of cords inclined at angles of zero to 5 degrees, relative to the circumferential direction of the tread 14. The layer 36 has a variable axial width, and depending on the tension requirements of the tread 14, the layer 36 may have a width greater or less than the axial width of the other belt package cord reinforcing layers 28, 30.

Axially outward of the lateral tread edges 18, 20, and radially inward of the ground contacting surface are hoop reinforcements 26. The hoop reinforcements 26 are unitary circular articles, providing tension at the extreme edges of the tread 14 and assisting in holding the tread 14 to the tread support 12. In a conventional pneumatic tire, the similar tire element, the tire beads, are inextensible hoops that aid in maintaining the tire on a wheel rim. Because a tire is provided with an internal air pressure, the tire beads are popped into place on the tire rim during inflation of the tire. Herein, there is no internal gas chamber for the non-pneumatic wheel, and thus no way to utilize gas pressure to pop the hoop reinforcements into place on the tread support.

To enable mounting of the tread 14, the hoop reinforcements 26 may be extensible, or compliant, to permit the hoop reinforcements 26 to move into the wells 38 provided in the tread support 12. For such an embodiment, the hoop reinforcements 26 must be extensible, but must also provide sufficient tension to hold the tread 12 taut. Alternatively, if the mounting means 10 and/or the tread support 12 are capable of collapsing and extending for purposes of mounting the tread 14 onto the tread support 12, the hoop reinforcements 26 may be inextensible hoops similar to bead rings of a pneumatic tire.

The hoop reinforcements 26 may be formed from materials such as steel or textile, with applicable textile materials being nylon, aramid, rayon, polyester. When the hoop reinforcements 26 are formed from a more inextensible material, such as steel, and the hoop reinforcements 26 must be extensible to permit mounting, the inextensible material is treated or shaped in a manner to provide the hoop reinforcements 26 with a degree of compliance. This may be accomplished by introducing twists into the inextensible material as it is wound to form the hoop reinforcements 26; such twisting being done on a group of cords when forming the hoop reinforcement 26 or when forming individual cords that will be gathered in some manner to form the hoop reinforcements 26. The required degree of compliance of the hoop reinforcement 26 may also vary depending upon the type of rim 12 being used and how the tread 14 is secured onto the rim, see further discussion below regarding rim variations.

The hoop reinforcements 26 have an overall diameter D, and are spaced apart from one another by an axial width WH, as measured from the axially innermost surface point of each hoop reinforcement 26. The hoops 26 are illustrated as being circular in cross-sectional configuration, but may have any cross-sectional configuration, including triangular, oblong, or any rectilinear configuration. The actual cross-sectional configuration is dependent upon the required physical properties of the hoop reinforcements 26.

In addition to the hoop reinforcements 26 being located radially inward of the ground contacting surface 26, the hoop reinforcements 26 are located radially inward of the primary reinforcement layer 24. To place the hoop reinforcements 26 radially inward of the primary reinforcement layer 24, the hoop reinforcements are enveloped by an elastomeric layer 40 that extends between both hoop reinforcements 26. The elastomeric layer 40 may or may not be cord reinforced. If the layer 40 is cord reinforced, the cords are inclined at an angle of 15 to 45 degrees relative to the circumferential direction of the tread 14. To shape the lower edge of the tread 14 in the area of the hoop reinforcements 26, the hoop reinforcements may be enveloped by an elastomeric chipper 42 and provided with a triangular insert 44.

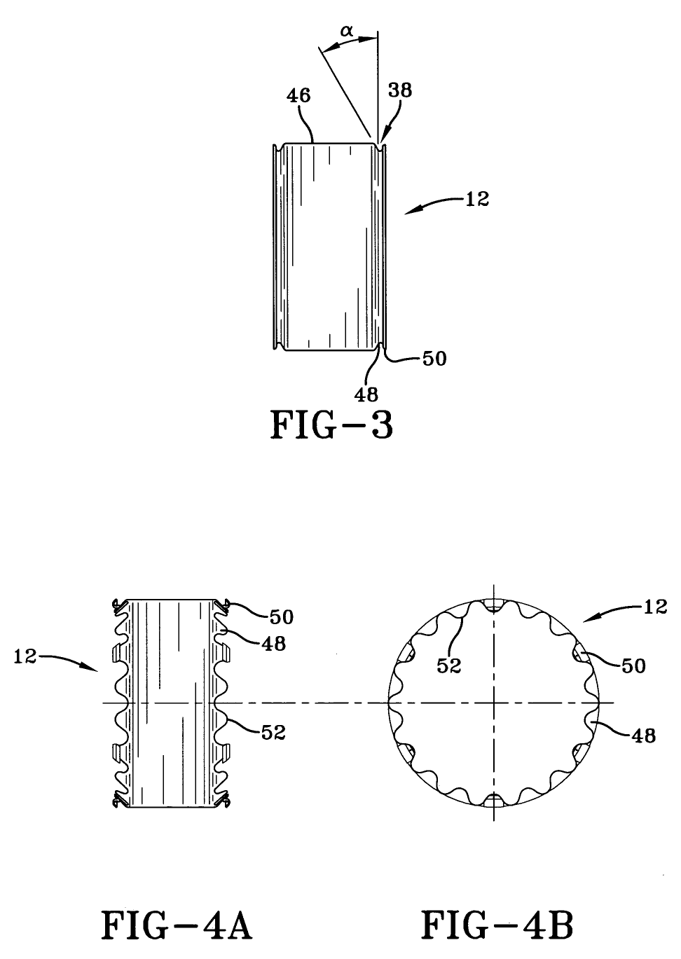

The tread support 12 is shown in cross-section in FIG. 1 in combination with the mounting means 10 and the tread 14, and by itself in FIG. 3. As noted already, the tread support 12 has mounting wells 38 at the axially outermost edges of the support 12. Located between opposing mounting wells 38 is a central rim 46 which makes full contact with the radially inner side of the tread 14. The wells 38 are formed by a support wall 48 and a flange 50. The support wall 48 extends from the central rim 46 and is inclined at an angle a between 30° and 60° relative to the radial direction of the tread support 12. In this illustrated embodiment, the wells 38 and the flange 50 are continuous around each lateral, or axial, edge of the tread support 12.

In the tread support 12 of FIGS. 4a and 4b, the mounting wells 38 are discontinuous about the circumferential lateral edges of the tread support 12. The lateral edges of the tread support 12, specifically the support walls 48, are discontinuous. The support walls 48 are shown as having a sinusoidal edge configuration; however the support wall edges 52 may have any configuration, including triangular, octagonal, and hexagonal. To secure the edges of the tread 14 onto the tread support 12, the discontinuous lateral edges are provided with intermittent flanges 50. The flanges 50 may be provided at every location wherein there is a support wall 48 or may be provided in numbers sufficient to retain the tread 14 on the tread support 12. In the illustrated embodiment, the flanges 50 are provided intermittently about the circumference of the tread support 12, located at every third support wall 48. Even with the discontinuous mounting wells 38, the flanges 50 may be integrally formed with the support walls 48, or may be formed separately and afterwards secured to the tread support 12. Such securing means includes, but is not limited to, bolting, welding, or adhesively securing the flanges 50. Similarly, for the continuous mounting wells 38 and flanges 50 of FIG. 3, the flanges may be separately formed and separately secured to the tread support 12.

The present invention yields a lightweight, non-pneumatic alternative wheel. The structure of the tread and the tread support provide for easy assembly of the non-pneumatic wheel.

What is claimed is:

1. A non-pneumatic wheel, the wheel comprising a mounting means, a tread support, and a tread, the tread being an annular article defined by opposing lateral edges, the tread comprising a ground contacting surface, a belt package, a primary reinforcement layer and a pair of hoop reinforcements in the lateral edges, the tread being characterized by
the hoop reinforcements being located radially inward and axially outward of the ground contacting surface.

2. The non-pneumatic wheel of claim 1 wherein the primary reinforcement layer is a cord reinforced layer, the cords being inclined at an angle in the range of 0° to 15° relative to the circumferential direction of the tread.

3. The non-pneumatic wheel of claim 1 wherein the primary reinforcement layer is a cord reinforced layer, the cords being selected from the material group consisting of steel, aramid, and nylon.

4. The non-pneumatic wheel of claim 1 wherein the primary reinforcement layer is a steel cord reinforced layer, the cords having a diameter of at least 1.4 mm.

5. The non-pneumatic wheel of clam 1 wherein the ground contacting surface has a defined width W, and the primary reinforcement layer is a cord reinforced layer having an axial width WR between the outermost reinforcing cords, the width WR being less the width W of the ground contacting surface.

6. The non-pneumatic wheel of claim 1 wherein the belt package is located radially outward of the primary reinforcing layer, and is comprised of at least two layer of cord reinforced ply.

7. The non-pneumatic wheel of claim 1 wherein the hoop reinforcements are located radially inward of the primary reinforcing layer.

8. The non-pneumatic wheel of claim 1 wherein the hoop reinforcements are enveloped by elastomeric chipper layers.

9. The non-pneumatic wheel of claim 1 wherein the tread support is an annular article defined by opposing lateral edges, the tread support comprising a central rim, and a mounting well at each lateral edge, wherein the hoop reinforcements of the tread sit within the mounting wells.

10. The non-pneumatic wheel of claim 9 wherein the tread support further comprising a flange located at the axially outer side of each mounting well.

11. The non-pneumatic wheel of claim 10 wherein each mounting well is continuous along the annular length of the tread support.

12. The non-pneumatic wheel of claim 10 wherein each mounting well is discontinuous along the annular length of the tread support.

13. The non-pneumatic wheel of claim 10 wherein the flange is integrally formed with the mounting wells when the tread support is manufactured.

14. The non-pneumatic wheel of claim 10 wherein the flange is mechanically secured to the mounting wells.

15. A non-pneumatic wheel, the wheel comprising a mounting means, a tread support, and a tread, the tread being an annular article defined by opposing lateral edges, the tread comprising a ground contacting surface, a belt package, a primary reinforcement layer and a pair of hoop reinforcements in the lateral edges, the tread being characterized by
the hoop reinforcements being located radially inward and axially outward of the primary reinforcement layer.

16. A non-pneumatic wheel, the wheel comprising a mounting means, a tread support, and a tread, the tread being an annular article defined by opposing lateral edges, the tread comprising a ground contacting surface, a belt package, a primary reinforcement layer and a pair of hoop reinforcements in the lateral edges, the tread support being characterized by
the tread support comprising a central rim, and a mounting well at each lateral edge, wherein the hoop reinforcements of the tread sit within the mounting wells.

17. The non-pneumatic wheel of claim 16 wherein each mounting well is discontinuous along the annular length of the tread support.

18. The non-pneumatic wheel of claim 16 wherein the tread support further comprising a flange located at the axially outer side of each mounting well, and the flange is integrally formed with the mounting wells when the tread support is manufactured.

19. The non-pneumatic wheel of claim 16 wherein the tread support further comprising a flange located at the axially outer side of each mounting well, and the flange is mechanically secured to the mounting wells.
